(19) United States
(12) Patent Application Publication
(10) Pub. No.: US 2026/0053710 A1
(43) Pub. Date: Feb. 26, 2026

(54) WORK STATIONS FOR PREPARATION OF MEDICAL DOSES

(71) Applicants: Baxter International Inc., Deerfield, IL (US); Baxter Healthcare SA, Glattpark (Opfikon) (CH)

(72) Inventors: Amanda Gloria Jacobs, Chicago, IL (US); Gregory Dean Kramer, DeLand, FL (US); Jeffrey Robert Brittain, Charleston, SC (US)

(21) Appl. No.: 19/306,437

(22) Filed: Aug. 21, 2025

Related U.S. Application Data
(60) Provisional application No. 63/685,531, filed on Aug. 21, 2024.

(51) Int. Cl. A61J 7/00; H04N 7/18; H04N 23/51; H04N 23/62

(52) U.S. Cl. CPC A61J 7/0069; H04N 7/183; H04N 23/51; H04N 23/62; A61J 2200/74

(57) ABSTRACT

Improved medical dose preparation work stations and accessories are described. The medical dose preparation work station includes a camera for capturing medical dose preparation images (e.g., to document preparation of a mediation dose). The camera may be actuated by an operator using a plurality of membrane buttons on a base of the medical dose preparation work station. The medical dose preparation work station further includes an adjustable arm to hold the camera at a desired focal length from a staging area defined by a tray such that objects in the images from the camera remain in focus. The tray includes a light side and a dark side configured to provide a high contrast background for an operator and for the camera.

### PRIORITY CLAIM

This application claims the benefit of and priority to U.S. Provisional App. 63/685,531, titled “IMPROVED WORK STATIONS FOR PREPARATION OF MEDICAL DOSES”, filed August 21, 2024, the entire contents of which are hereby incorporated by reference.

### BACKGROUND OF THE INVENTION

Many care providers have a pharmacy that prepares medical doses for administration to patients that are treated by the care provider. In this regard, the pharmacies may employ a formulary to prepare medications in order to fulfill medical dose orders that are ordered by care provider personnel (e.g., physicians) for administration to patients. Some medical doses to be prepared may include compounded sterile products (CSPs) that may be prepared in a specially constructed and controlled environment (e.g., an “IV Room”) in the pharmacy. The process of preparing medical doses may be carried out in accordance with local care provider policy, governmental regulations, industry organizations (e.g., Chapter <797> of the United States Pharmacopoeia), or other applicable policies. For example, the preparation of medications may generally occur in a laminar airflow hood, isolator, or biological safety cabinet, by an operator (typically a pharmacy technician) who is tasked with preparing the medical doses. Once the medical doses are prepared, the medical doses may be required to be verified by a pharmacist prior to being dispensed from the pharmacy for administration to a patient.

In traditional pharmacy management techniques, medical dose orders may be provided to a printer that prints labels indicative of the medical dose order that are to be applied to finished doses once the doses are prepared. A pharmacy technician may be required to retrieve labels from a label printer and use those labels as work order travelers in the process of preparing each dose. Once the dose is prepared, the technician may apply a label to the dose. The completed, labeled dose may be set aside for a pharmacist to check along with, for example, source ingredients, medication receptacles used in the course of preparing the dose, and/or other material. In this regard, in order to check a dose, the pharmacist may be required to enter the clean room in which the doses are prepared and physically observe the materials associated with the dose order. As such, the checking of prepared doses may require the pharmacist to dress in protective clothing or equipment, which takes time and resources.

Furthermore, checking and verifying the doses may include steps such as recording an image of the dose during preparation or weighing the dose during preparation using a scale outside of the dose preparation stage. These steps may require the actuation of buttons or the use of equipment outside of the sterile field in which the dose is being prepared, which requires an operator to perform another sterilization step before resuming the dose preparation, taking more time and resources.

Furthermore, certain medications or container characteristics may be difficult to see on the image acquired during dose preparation, which may be due in part to the color of the dose preparation stage which acts as a background for these images. Some medications and compounds may exhibit color changes or precipitate out of solution if incorrect dosages are combined. The medications and compounds are typically inappropriate for administration if this condition occurs, but the color changes and precipitates are not always easy to detect with the naked eye. For example, two clear compounds may turn a white color or form a precipitate when mixed if those compounds are incompatible for human infusion. Current medical dose preparation work stations tend to have a white or light gray staging area, which aids in identifying coring during dose preparation, but may not offer necessary contrast during imaging for identifying color changes in the compounds.

Further still, many medical dose preparation work stations include an imaging device used to capture still photos or video streams of the compounds being prepared for verification and recordation purposes. The focal length of the imaging device tends to be configured to rest at or just above the level of the staging area in order to maintain focus on the containers and compounds being prepared. However, some compounds require the use of gravimetric measurement to confirm correct dosages and compound levels. If a scale is added to the staging area, the added height can bring the containers and compounds out of the range of the focal length and cause images to be out of focus, making verification difficult.

Hence, improved work stations for the preparation of medical doses that retain sterility for an operator, offer modular background color choices, and maintain imaging device focal length are needed.

### SUMMARY OF THE INVENTION

In this regard, the present disclosure relates to embodiments of a medical dose preparation work station. A work station at which a dose order is prepared may include an imaging device (e.g., a digital camera) capable of capturing images related to the preparation of the medical dose. In an embodiment, the medical dose preparation images may include medication receptacles used in the preparation of the dose including, for example, a source receptacle, a transference receptacle, and/or an administration receptacle. Accordingly, the medical dose preparation images may be used to document or evidence the preparation of a medical dose order. Because the images are used as evidence of the preparation of a medical dose order, there is increased importance on ensuring that these images are in focus, in order that an operator or reviewer may correctly identify components of the image. The present disclosure provides means to ensure that the images are in focus, by providing an adjustable arm to hold the imaging device at a constant distance above a staging area of the work station.

Given the need for accuracy, it may also be advantageous to provide geometries within the work station which help nest the components being imaged, such that consistent placement of the components is achieved. For example, providing a channel in the staging area of the work station configured to nest a syringe with a label facing toward the camera is likely to reduce errors in medical dose verification.

Further, providing the highest possible contrast between the component being imaged or viewed and the background may help an operator identify foreign bodies in a medical dose or recognize when color changes occur in the doses that signify a medicament error has occurred. In this respect, it the present disclosure provides a work station that is modular between a light color background and a dark color background so that these conditions can be more easily identified and reduce the amount of avoidable medicament errors from a pharmacy.

Another advantage of the present disclosure is to provide a work station wherein the height of the camera is adjustable in order to maintain focal point distance between the camera and the staging area, especially when gravimetric dose preparation requires the addition of a scale below the staging area. To this end, a work station with an adjustable-length umbilicus to the camera portion is provided to efficiently resolve this issue.

Finally, the disclosure provides a work station configured to cause an image to be captured at the point of preparation and maintaining a sterile environment, which in turn markedly improves the action of causing the image to be captured at the work station. Operators of a work station often have to perform multiple sterilization steps to complete a single medicament batch because an actuator button configured to cause the camera to capture an image is located outside of the sterile field, such as at the operator’s working computer. A work station with buttons built in to control the capture function of the camera in the sterile field is advantageous. Further, membrane buttons configured to provide greater dexterity to an operator wearing sterile gloves are also advantageous.

The presently disclosed work station includes these advantages and others by providing a medical dose preparation staging region with a modular background, wherein in one position a tray defining a medical dose preparation staging region provides a light color background and in another position the tray provides a dark color background. Images of the dose preparation staging region may be captured by a camera of the work station with a focal point at or near the surface of the tray. The camera is held in place by an adjustable arm which may be replaced by an arm of a different length in order to maintain the position of the tray relative to the focal point of the camera. The tray may also include a channel configured to nest a syringe or medicament container for simplified image capture. The work station may also include membrane buttons that are kept inside of the sterile environment, are configured to provide proper dexterity for an operator using gloves, and are operatively coupled to a processor which is in turn operatively coupled to the camera, such that images can be captured with the actuation of the buttons.

In this regard, a first aspect described herein, which may be combined with any other aspect herein unless otherwise noted, includes a medical dose preparation work station. The work station includes a base, an imaging device (e.g. a camera) disposed inside an imaging device housing of the work station, wherein the imaging device has an imaging field configured to approximate a medical dose preparation staging region, and wherein the imaging device is operatively coupled to a processor. The imaging device may be operable to output digital image data of the imaging field including the medical dose preparation staging region. The work station further includes an adjustable arm configured to couple the imaging device housing to a base of the work station. The work station further includes at least one membrane button disposed on the base of the work station in operative communication with the processor. The at least one membrane button is configured to cause the imaging device to capture an image when actuated. The work station further includes a tray comprising a perimeter corresponding to a boundary of the imaging field and defining the medical dose preparation staging region, wherein the tray further comprises a first side of a substantially light color and a second side of a substantially dark color, wherein the first side and second side are disposed on generally opposite sides of the tray and wherein the tray is configured to be flippable and reversible in the work station. The processor in operative communication with the imaging device and display device is configured to receive input from the at least one button and provide input commands to the imaging device and/or advance a workflow process.

In another aspect of the current disclosure, which may be combined with any other aspect herein unless otherwise noted, the tray further comprises a plurality of peaks on each of the first side and the second side. The series of peaks may be helpful to an operator by allowing a syringe or other medicament container to rest on the surface of the tray temporarily, for example if an operator needs to turn away from the work station to pick up a second medicament container, or in order to effectively position a medicament container or other object for proper image capture relative to the position of the camera. In a further aspect, which may be combined with any other aspect herein unless otherwise noted, each peak comprises a pyramidal structure having a square base.

In another aspect of the current disclosure, which may be combined with any other aspect herein unless otherwise noted, the tray further comprises a plurality of channels on each of the first side and the second side. These channels provide an area to nest a syringe or medicament container while capturing an image for consistent placement. In a further aspect, which may be combined with any other aspect herein unless otherwise noted, these channels separate the tray into subregions, wherein the channels define perimeters of a plurality of subregions on each of the first side and the second side of the tray. In a further aspect, which may be combined with any other aspect herein unless otherwise noted, the tray comprises five channels on each of the first side and the second side.

In another aspect of the current disclosure, which may be combined with any other aspect herein unless otherwise noted, the base further comprises at least one alignment knob and the tray further comprises at least one indent configured to align with the at least one alignment knob. This allows for consistent placement of the tray on the base and ensures that the tray does not shift out of alignment once placed on the base.

In another aspect of the current disclosure, which may be combined with any other aspect herein unless otherwise noted, the at least one button comprises a membrane button configured to be sterilizable.

In another aspect of the current disclosure, which may be combined with any other aspect herein unless otherwise noted, the base comprises a first connector, and the imaging device housing comprises a second connector, and the adjustable arm is configured to be coupled to the imaging device housing and the base by the first and second connectors. In a further aspect, which may be combined with any other aspect herein unless otherwise noted, the adjustable arm comprises a length configured to be removably coupled to the first and second connectors. In yet a further aspect, which may be combined with any other aspect herein unless otherwise noted, the adjustable arm is interchangeable with a second adjustable arm of a different length than the adjustable arm, the second adjustable arm configured to be coupled to the imaging device housing and the base by the first and second connectors. In yet a further aspect, which may be combined with any other aspect herein unless otherwise noted, the second adjustable arm comprises a length configured to correspond to ta focal length of the imaging device such that an object on the tray is in focus of the imaging device when a scale is disposed between the tray and the base.

In another aspect of the current disclosure, which may be combined with any other aspect herein unless otherwise noted, the work station further comprises a scale disposed between the tray and the base. In a further aspect, which may be combined with any other aspect herein unless otherwise noted, the work station further comprises an adapter configured to be disposed between the tray and the scale, wherein the adapter comprises a cutout portion adapted to substantially surround a weighing surface of the scale. In yet a further aspect, which may be combined with any other aspect herein unless otherwise noted, the adapter further comprises at least one flange configured to be disposed at least partially between the at least one alignment knob of the base and the at least one indent of the tray. In yet a further aspect, which may be combined with any other aspect herein unless otherwise noted, the adapter further comprises a plurality of seats, and the tray further comprises a plurality of contact points on each of the first side and the second side, the contact points arranged to be seated on the seats of the adapter and align the tray with the adapter.

In another aspect of the current disclosure, which may be combined with any other aspect herein unless otherwise noted, the work station is configured to be sterilizable and is further configured to be able to be used in a sterile environment. In a further aspect, which may be combined with any other aspect herein unless otherwise noted, the sterile environment is the inside of a hood.

In another aspect of the current disclosure, which may be combined with any other aspect herein unless otherwise noted, the work station is configured for use in a pharmacy of a hospital.

In another aspect of the current disclosure, which may be combined with any other aspect herein unless otherwise noted, the work station is configured for use in a pharmacy outside of a hospital. The pharmacy may be a standalone pharmacy for home care patients.

In another aspect of the current disclosure, which may be combined with any other aspect herein unless otherwise noted, a tray of a medication preparation work station is provided, the tray comprising a first side of a substantially light color, and a second side of a substantially dark color, wherein the first side and the second side are disposed on generally opposite sides of the tray.

In another aspect of the current disclosure, which may be combined with any other aspect herein unless otherwise noted, the tray further comprises a plurality of peaks on each of the first side and the second side.

In another aspect of the current disclosure, which may be combined with any other aspect herein unless otherwise noted, each peak comprises a pyramidal structure having a square base.

In another aspect of the current disclosure, which may be combined with any other aspect herein unless otherwise noted, the tray further comprises a plurality of channels on each of the first side and the second side.

In another aspect of the current disclosure, which may be combined with any other aspect herein unless otherwise noted, the channels define perimeters of a plurality of subregions on each of the first side and the second side of the tray.

In another aspect of the current disclosure, which may be combined with any other aspect herein unless otherwise noted, an adapter for a medication preparation work station is provided, the adapter comprising a body, a cutout portion, and at least one flange configured to be disposed at least partially between at least one alignment knob of a base of the medication preparation work station and at least one indent of a tray, wherein the cutout portion is adapted to substantially surround a weighing surface of a scale.

In another aspect of the current disclosure, which may be combined with any other aspect herein unless otherwise noted, the adapter further comprises a plurality of seats, wherein the seats are configured to seat and align with a plurality of contact points of the tray.

In another aspect of the current disclosure, which may be combined with any other aspect herein unless otherwise noted, the adapter is configured to be removable from the medication preparation work station.

Numerous additional features and advantages of the present invention will become apparent to those skilled in the art upon consideration of the embodiment descriptions provided hereinbelow.

### BRIEF DESCRIPTION OF THE FIGURES

FIG. 1A is an isometric view of an embodiment of a medical dose preparation work station.

FIG. 1B is the isometric view of FIG. 1A wherein the flippable staging area tray is removed from the view.

FIG. 1C is the isometric view of FIG. 1B wherein the scale-to-tray adapter is included.

FIG. 1D is a side perspective view of an embodiment of a medical dose preparation work station wherein the flippable staging area tray and one of the plates of the arm are removed from view.

FIG. 1E is a bottom perspective view of an embodiment of a medical dose preparation work station wherein the flippable staging area tray is removed from view.

FIG. 1F is a top view of an embodiment of a medical dose preparation work station.

FIG. 1G is a bottom view of an embodiment of a medical dose preparation work station.

FIG. 1H is a left side view of an embodiment of a medical dose preparation work station.

FIG. 1I is a front view of an embodiment of a medical dose preparation work station.

FIG. 2A is an isometric view of an embodiment of a flippable tray of a medical dose preparation work station.

FIG. 2B is a top view of the flippable tray of a medical dose preparation work station of FIG. 2A.

FIG. 2C is a bottom view of the flippable tray of a medical dose preparation work station of FIG. 2A.

FIG. 2D is a front view of the flippable tray of a medical dose preparation work station of FIG. 2A.

FIG. 2E is a left side view of the flippable tray of a medical dose preparation work station of FIG. 2A.

FIG. 3A is an isometric view of an embodiment of a scale-to-tray adapter of a medical dose preparation work station.

FIG. 3B is a top view of the scale-to-tray adapter of a medical dose preparation work station of FIG. 3A.

FIG. 3C is a bottom view of the scale-to-tray adapter of a medical dose preparation work station of FIG. 3A.

FIG. 3D is a left side view of the scale-to-tray adapter of a medical dose preparation work station of FIG. 3A

FIG. 3E is a front view of the scale-to-tray adapter of a medical dose preparation work station of FIG. 3A.

FIG. 4 is a schematic diagram of a pharmacy preparation system according to an embodiment of the present disclosure.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

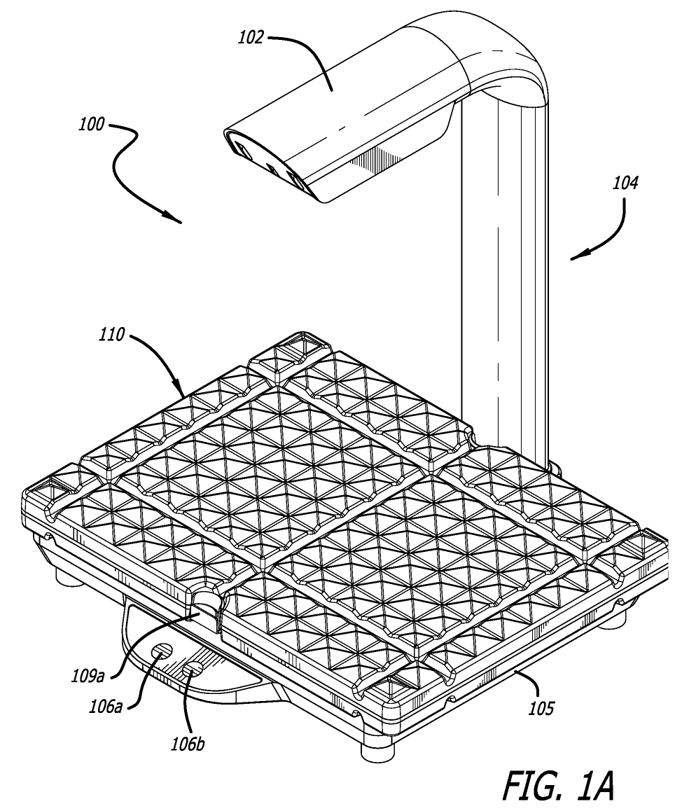

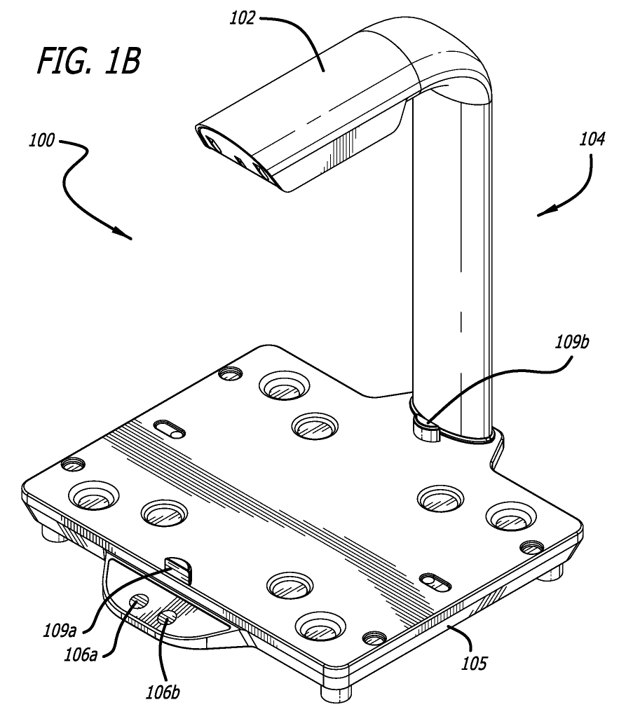

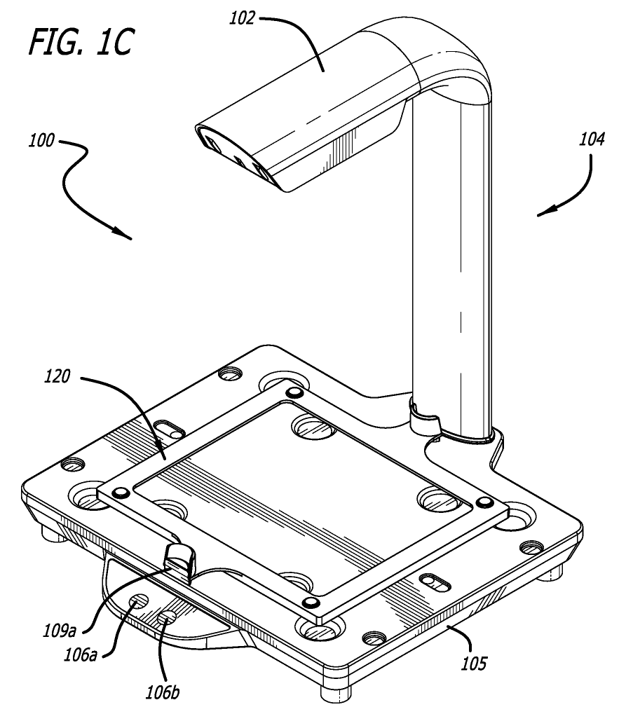

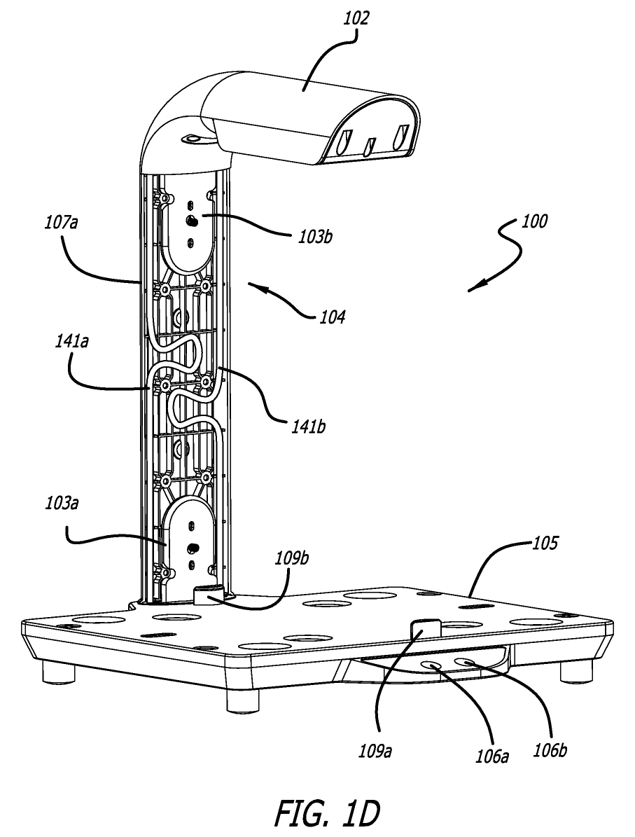

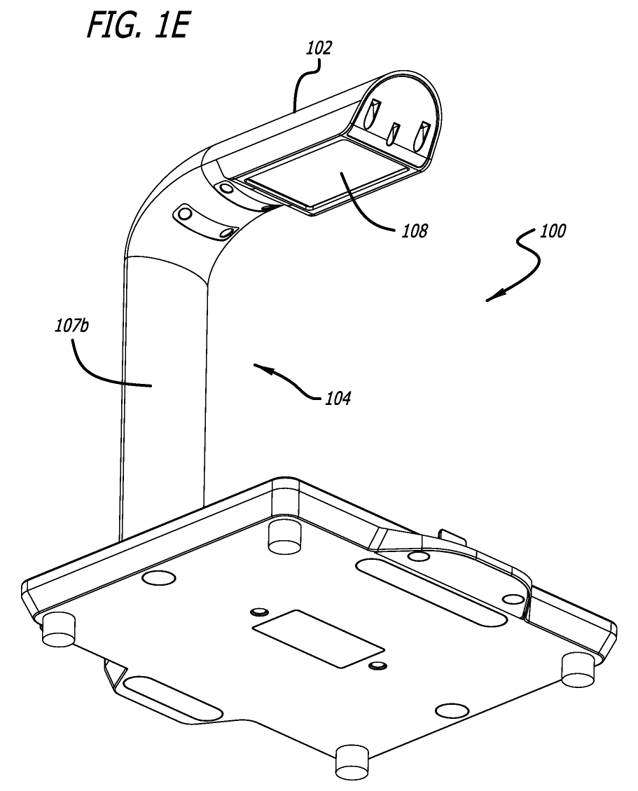

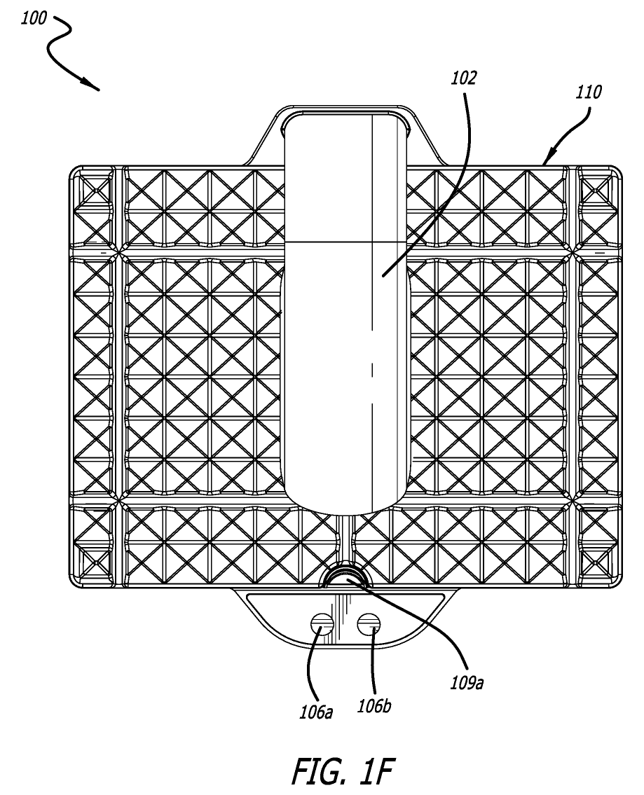

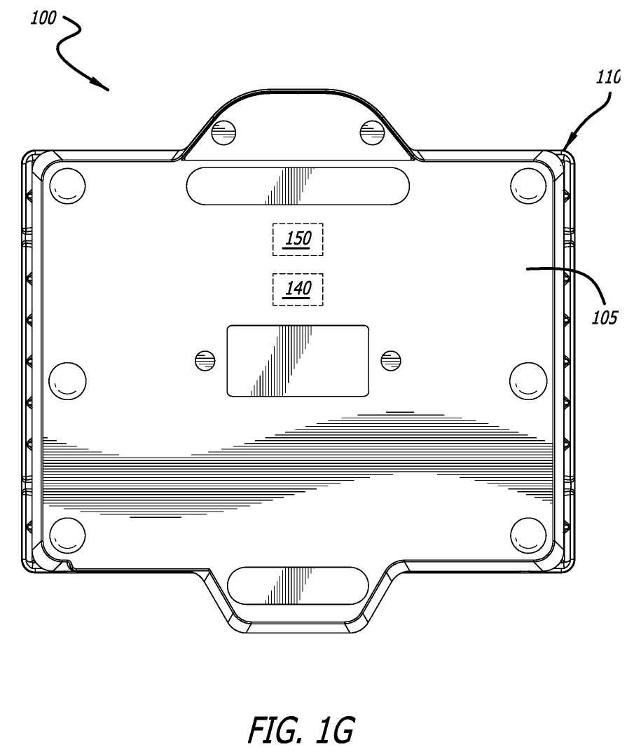

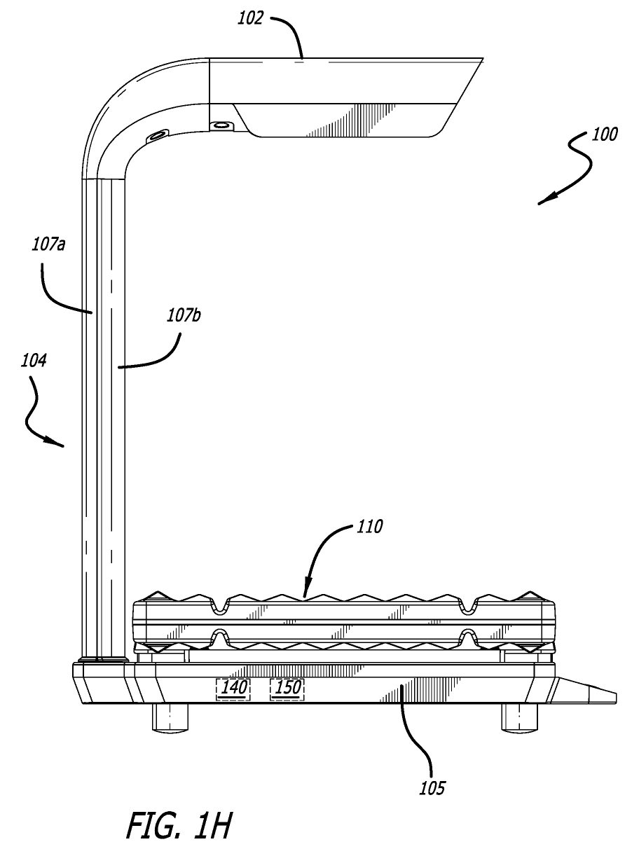

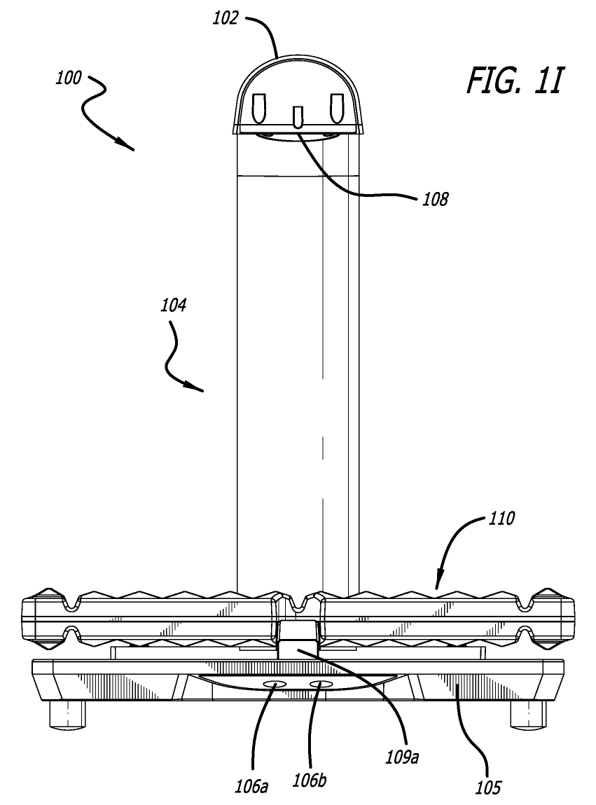

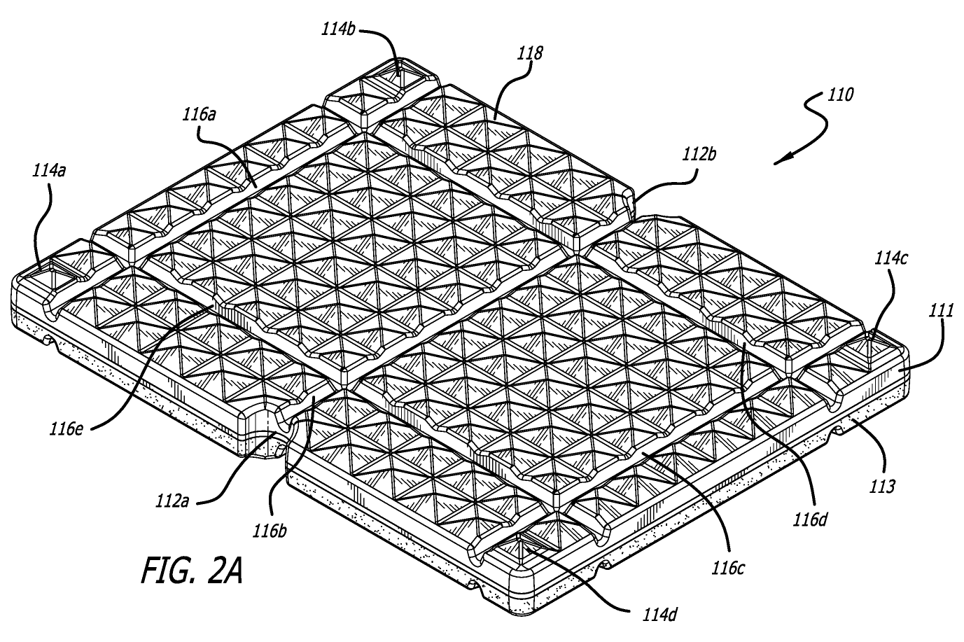

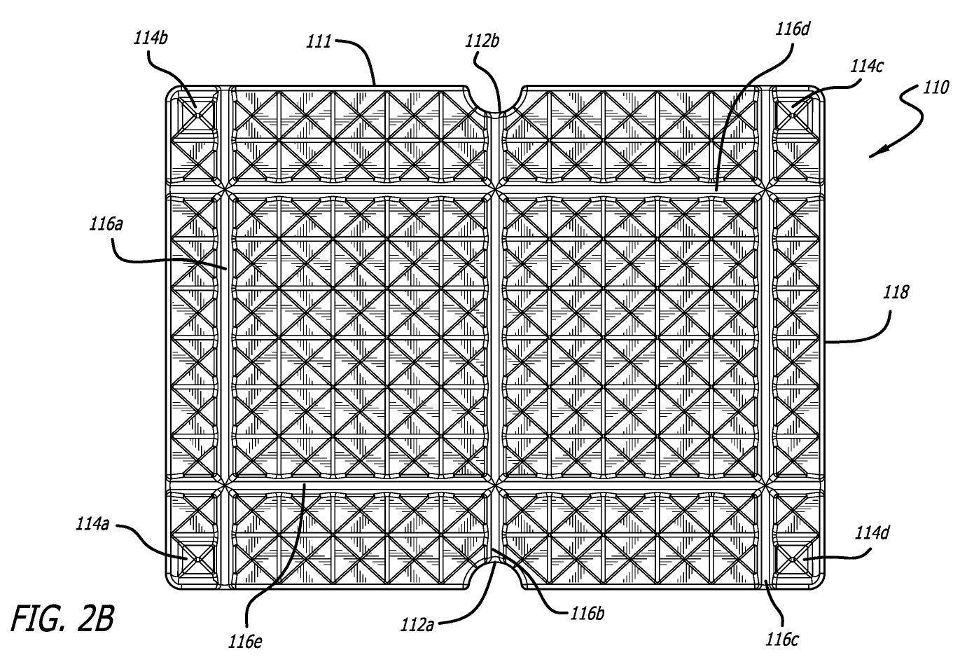

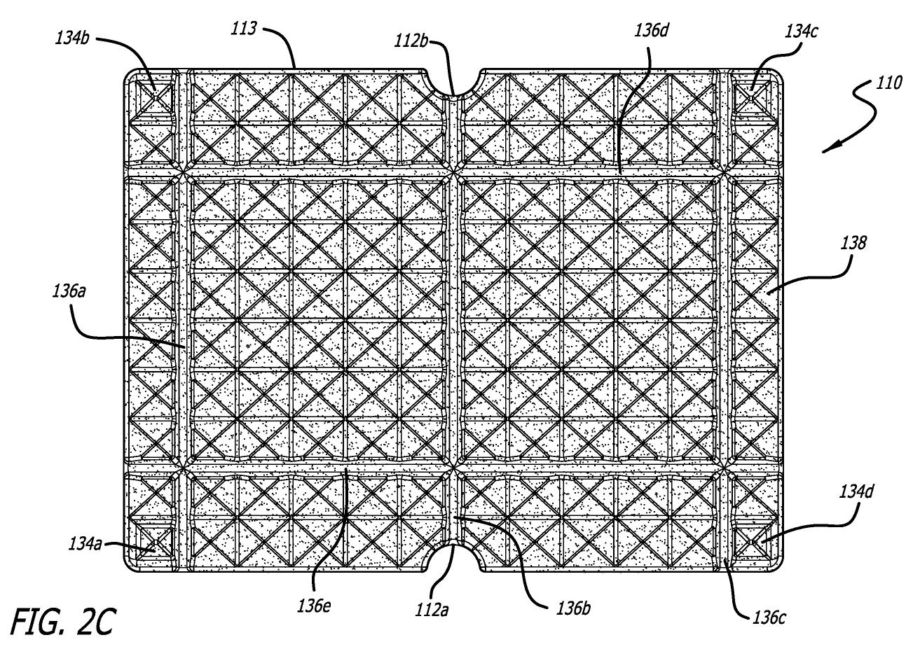

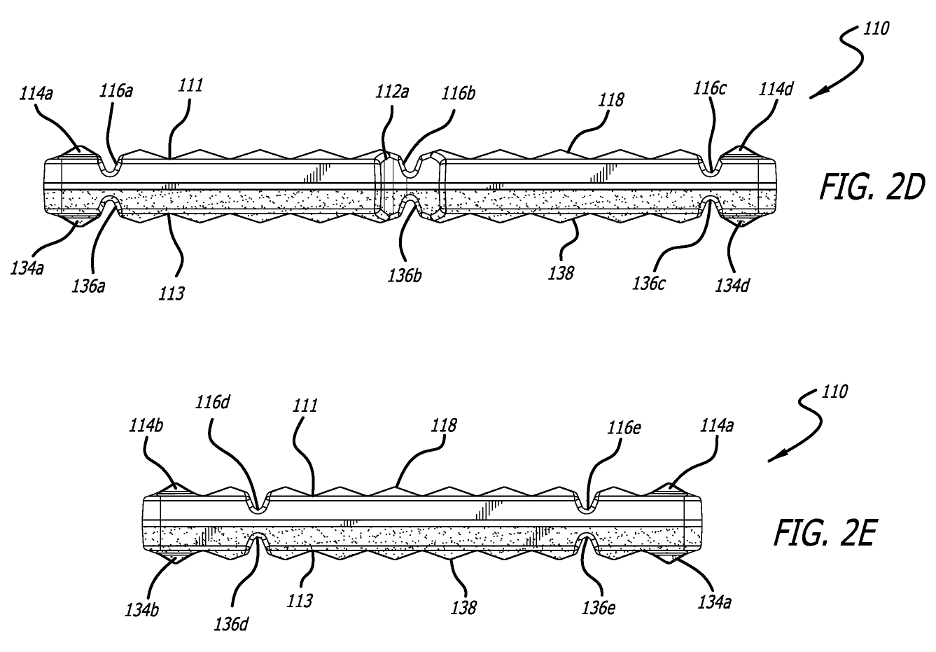

Turning to FIGS. 1A-1I, a medical dose preparation work station 100 comprises a base 105, a flippable staging area tray 110, a camera housing 102, an adjustable arm 104, at least one alignment knob 109a, 109b, and buttons 106a, 106b. The camera housing 102 houses a camera 108 which is configured to monitor the staging area, defined approximately to the flippable staging area tray 110. The staging area is an area of the medical dose preparation work station 100 provided for and configured to allow an operator to perform the tasks necessary to prepare a medication dose. For example, an operator may use this area to prepare an IV bag with the proper medicament for delivery to a patient in a hospital setting. Preparing such an IV bag may require the imputation of various drugs from vials, graduated cylinders, other bags, etc. In some embodiments, the staging area is defined by a surface of the flippable staging area tray 110. The flippable staging area tray 110 is configured to improve the ability of an operator to have these multiple containers on the staging area at one time, as described in further detail below (see description of FIGS. 2A-2E).

### Camera Focal Length and Adjustable Arm

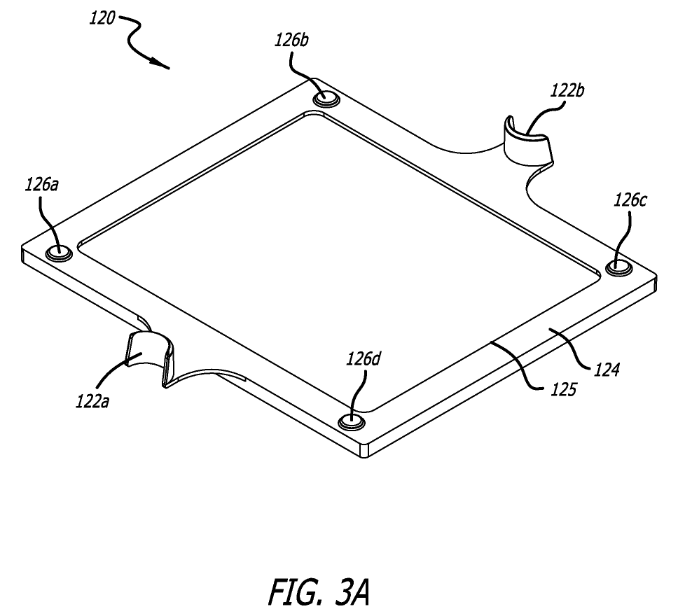

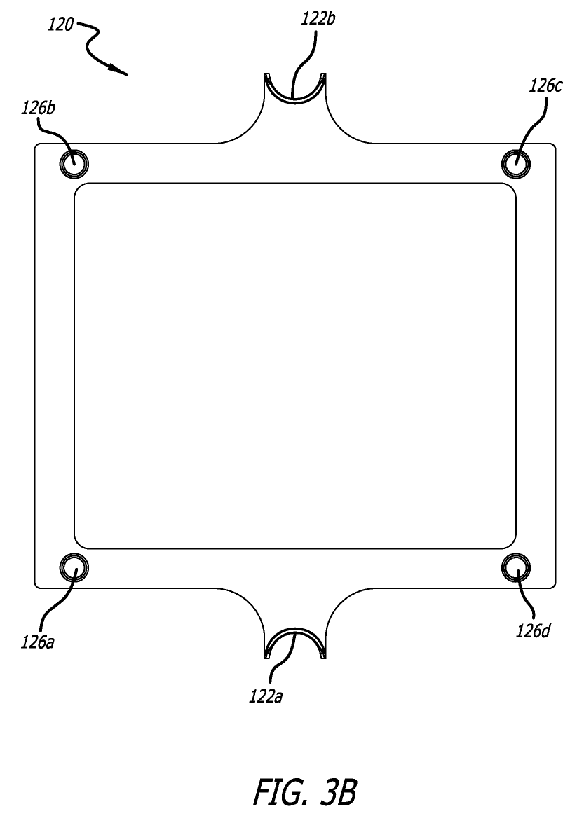

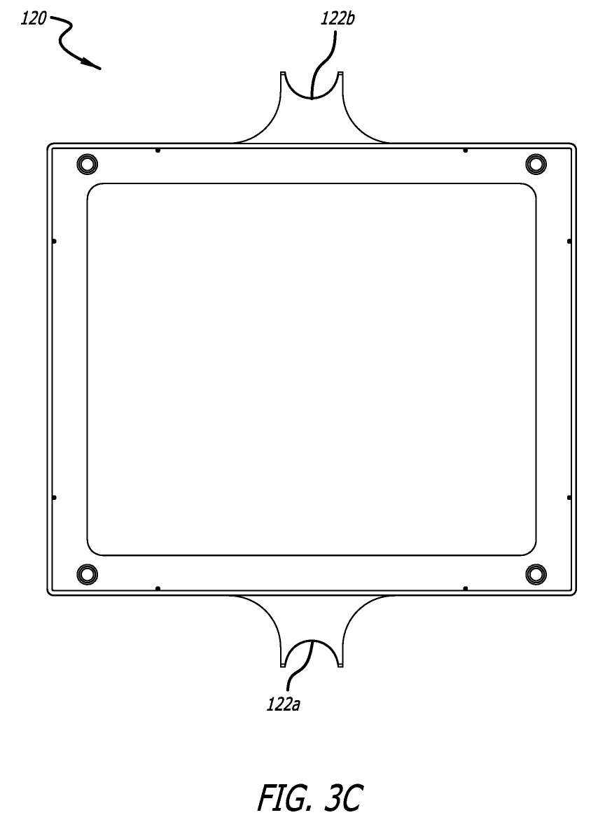

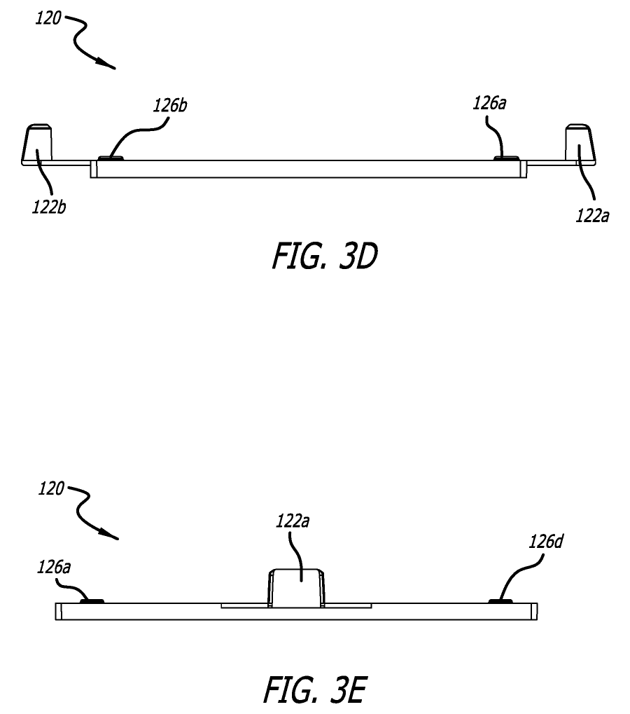

The camera 108 housed inside the camera housing 102 (illustrated in FIG. 1E) is configured to have a full view of the staging area. The camera 108 is used to capture images or videos of the medicament being prepared by an operator at the medical dose preparation work station 100. The focal length of the camera 108 is configured such that most medicament containers and containers of compounds used in the preparation of the medicaments are within focus, such that any labels on the containers are generally legible to a reviewer of the images or to optical character recognition software. In this way, images can be used for verification of the medicaments to be distributed to a patient. Because the flippable staging area tray 110 makes up the staging area in some embodiments, the flippable staging area tray 110 also makes up the background of the images captured by the camera 108 (more about this will be described in the description of FIGS. 2A-2E). However, any shift in the distance between the flippable staging area tray 110 and the camera 108 may cause the focal length to no longer have items on the flippable staging area tray 110 in focus. This shift in distance between the camera 108 and the flippable staging area tray may occur if the medical dose preparation work station 100 is configured to include a scale between the base 105 and the flippable staging area tray 110. This scale may be a commercially available scale ideal for weighing of medicament, such as the Mettler Toledo™ MX6002 precision scale in a preferred embodiment. Previous versions of scales may also be used, such as the Mettler Toledo™ MS6002S. However, any suitable scale may be used in the medical dose preparation work station 100. In this configuration, the flippable staging area tray 110, which normally rests on the base 105 of the medical dose preparation work station 100, may instead rest on the scale and interfere with the operation and accuracy of the scale. In order to overcome this issue, a scale-to-tray adapter 120 (shown in FIG. 1C) is included in this configuration to create proper clearance and balance between the scale and the flippable staging area tray 110. The scale-to-tray adapter 120 will be described in further detail in the description of FIGS. 3A-3E.

The focal length may be restored to the proper distance above the flippable staging area tray 110 by the adjustable arm 104 when a scale is employed. The adjustable arm 104 is configured to have at least two height options, one corresponding to a non-scale configuration of the medical dose preparation work station 100, and another corresponding to a scale configuration of the medical dose preparation work station. The adjustable arm 104 may be a set of two interchangeable components, each of a different length (corresponding to two different heights of the camera 108 when each adjustable arm 104 is installed). In this configuration, the base 105 and the camera housing 102 include connectors 103a, 103b, respectively, adapted to be received by the adjustable arm 104. The connectors 103a, 103b reach into the adjustable arm 104 consisting of a back panel 107a and a front panel 107b, where fasteners are employed to couple the back panel 107a to the back panel 107b, and other fasteners are employed to couple the adjustable arm 104 to the connectors 103a, 103b and create a secure coupling between the adjustable arm 104 and the base 105 and camera housing 102. In a preferred embodiment, the fasteners are commercially available screws. In another embodiment, tongue and groove joints are utilized between the adjustable arm 104 and the camera housing 102 and the base 105, such that when the screws are driven home, the tongue and groove joints mate between each component and resiliently couple the components together. In another embodiment, latches inside the adjustable arm 104 mate with indents on the connectors 103a, 103b in order to couple the adjustable arm 104 to the connectors 103a, 103b. In another embodiment, the camera housing 102 and the base 105 may be releasably coupled to the adjustable arm 104, such that an operator may actuate a release mechanism (such as at least one button) to release the adjustable arm 104 from the camera housing 102 and/or the base 105. The adjustable arm 104 may contain wiring or circuitry 141a, 141b that is modular between each length of component to maintain power to the camera 108 and connection between the camera 108 and the processor 140 (described in further detail below). Alternatively, the camera housing 102 and the base 105 may be releasably force-fit to the adjustable arm 104, such that an operator need only pull each component away from each other, overcoming a certain energy threshold, in order to release each component from the other and interchange the length of adjustable arm 104 used. In another embodiment, the adjustable arm 104 has a main component and an insert component. The main component may be configured to the height necessary to maintain proper focal length in the non-scale configuration, and the insert component may be a component that is inserted between the main component of the adjustable arm 104 and the base 105 or between the main component of the adjustable arm 104 and the camera housing 102 and is configured to correspond to the increased height of the flippable staging area tray 110 in the scale configuration, such that the same focal length is maintained between the flippable staging area tray 110 and the camera 108 when the insert component is inserted. The insert component may be adapted to give a seamless appearance between the adjustable arm 104 and the camera housing 102 and/or the base 105, such that the aesthetic appearance of the medical dose preparation work station 100 is maintained, even in the scale configuration. In yet another embodiment, the adjustable arm 104 has a telescoping design, such that the adjustable arm is a single component which is slidable such as to be height adjustable. At least one clamp may be utilized in such an embodiment to selectively maintain the height of the adjustable arm 104 at a desired level. The clamp may be built-in to the adjustable arm 104 and sit flush within the perimeter of the adjustable arm 104 with a small indent for an operator to place a finger in order to actuate the clamp mechanism while maintaining aesthetic appearance of the medical dose preparation work station 100. Further, the design of the adjustable arm 104 with the telescoping height adjustment is preferably adapted to have a smooth profile in any position in order to maintain aesthetic appearance of the medical dose preparation work station 100.

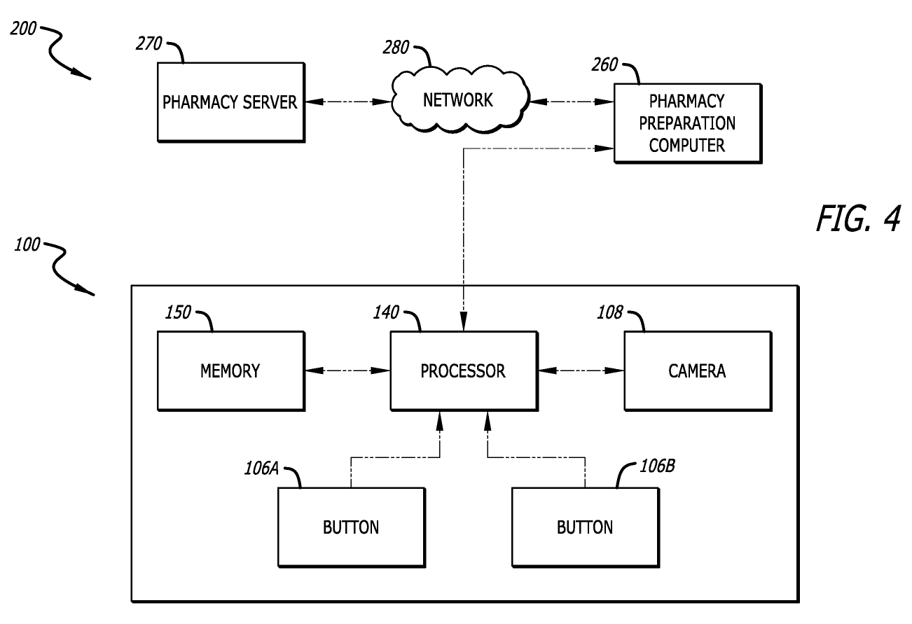

As described in further detail with regard to FIG. 4, the camera 108 may be communicatively coupled to a processor 140, which may be internal to the medical dose preparation work station 100 or external to it (such as housed on a computer to which the dose preparation work station 100 is communicatively coupled). The processor 140 may also be a processor already internal to the camera 108 as well. The camera 108 is preferably a high resolution camera in order to capture images sufficient for verification of medicament container labels and compound identities. At least one button 106a, 106b is also communicatively coupled to the processor 140 and is configured to actuate certain features of the camera. For instance, button 106a may be configured to cause the camera 108 to take a picture when actuated, while button 106b may be configured to cause the camera 108 to start or stop a video recording when actuated. The at least one button 106a, 106b may alternatively be configured to cause certain features of the medical dose preparation work station 100 to operate when actuated. For instance, button 106b may alternatively cause a verification step to be marked as verified when actuated. The work station may also include a memory 150 which stores machine readable instructions for dose preparation, such as the necessary series of verification steps to be completed by an operator. The verification steps may be provided to the operator via a user interface or screen during medical dose preparation. The machine-readable instructions may also include pharmacy workflow management software. The memory 150 may also store images captured by the camera 108. Although the memory 150 is internal to the medical dose preparation work station 100 in one embodiment, it is contemplated that the memory 150 may be stored externally and in wireless or wired communication with the processor 140. It is also contemplated that more than one memory 150 is present and communicatively coupled to the processor 140. One memory 150 may reside internally to the medical dose preparation work station 100 and another memory 150 may reside externally to the medical dose preparation work station 100, such as in a pharmacy preparation computer 260 (illustrated later on) or on a hospital network. Further, although one processor 140 is shown in the embodiment, it is contemplated that a series of processors 140 in operative communication may be included, and at least one processor 140 may be external to the medical dose preparation work station 140. The processors 140 may be in operative communication through wired or wireless connections. For instance, the camera 108 may have its own processor 140 in operative communication with a dedicated medical dose preparation work station processor 140 via a wired connection, where both processors 140 reside within the medical dose preparation work station 100, and the dedicated medical dose preparation work station processor 140 may be in operative communication with at least one processor 140 of a pharmacy preparation computer 260 external to the medical dose preparation work station 100 via a wireless connection. The pharmacy preparation computer 260 may provide the workflow to the medical dose preparation work station 100 and may further provide a screen or display for displaying the steps of the workflow to the operator during preparation of the medical doses. The pharmacy preparation computer 260 may be in operative communication via a network 280 with a pharmacy server 270 which enables an operator or user at the pharmacy preparation computer 260 to select a medication dose to prepare and then determine the corresponding dose protocol and workflow to present. In such an embodiment, updates to dose protocols can be made at the pharmacy server 270 and automatically be incorporated to the workflow displayed to an operator via the pharmacy preparation computer 260.

### Membrane Buttons

As described above, at least one button 106a, 106b is also communicatively coupled to the processor 140 and is configured to actuate certain features of the camera. The at least one button 106a, 106b is preferably a membrane button, meaning that the actuation surface of the button has a flexible polymer membrane cover. The medical dose preparation work station 100 often resides in a sterile or clean environment, and typically under a hood, meaning that an operator will typically have to apply protective equipment and perform a sterilization process before proceeding to prepare a medical dose. This process can be time-consuming and includes the use of disposable materials such as gloves, hair nets, sanitizers, etc. Every time an operator is required to step away from the environment of the medical dose preparation work station 100, it requires the operator to perform the time-consuming and product-consuming processes again. For instance, known medical dose preparation systems will have a camera-actuating button outside of the sterile field of the work station (usually near an operator’s computer or on a touchscreen outside of the hood), which requires the operator to step out of the sterile field, actuate the button to take the picture, perform sterilization steps once again, and then continue work on preparing the medical dose. Having at least one button 106a, 106b in the sterile field drastically reduces the amount of times an operator must repeat the sterilization process, saving time and reducing the amount of product waste associated with preparing medical doses. For instance, an operator may perform four verification steps during a single dose preparation, requiring the operator to apply sanitizer to the operator’s gloves four times and wait thirty seconds for the sanitizer to dry before returning to the work station each time. Furthermore, the membrane structure of the at least one button 106a, 106b improves the haptic feedback for an operator wearing rubber gloves and is a better option for maintaining sterility than plastic or metal buttons which may have small gaps surrounding them where particulate matter may fall and bacteria may be harbored.

### Flippable Staging Area Tray

Turning now to FIGS. 2A-2E, a more detailed account of the flippable staging area tray 110 is provided. The flippable staging area tray 110 in one embodiment includes at least one indent 112a, 112b, which is configured to easily allow an operator to pick up the flippable staging area tray 110 and flip it between the light side 111 and the dark side 113.

The flippable staging area tray 110 includes a light side 111 and a dark side 113 in order to accommodate the visualization and capture of images of containers and medicaments of different colors on the flippable staging area tray 110 during preparation of a medical dose. This ensures the highest possible contrast between the flippable staging area tray 110 (which acts as a background for the preparation) and the containers and medicaments resting on the flippable staging area tray 110. For instance, conventional medical dose preparation workstations only included a white or light-colored tray. Although many containers have dark markings, making a white background the highest contrast, this is not true in all cases. For instance, some syringes, vials, and graduated cylinders have white or translucent markings, making a dark background more suitable for their use. Furthermore, it may be advantageous to have a white background in order to see whether any contaminant has entered a liquid medicament, such as if a part of a vial stopper has inadvertently fallen into a liquid medicament (for example, an IV bag), a condition known as “coring”. The dark piece of vial stopper in the transparent liquid will have the highest contrast when shown against a white background. Further, some drugs may exhibit color changes or precipitate out of solution when an incorrect dosage or combination of components has occurred, which could be used as a safety feature. In many medicaments, this color change manifests as normally transparent liquids combining to form white particulates, making a dark background a more preferable choice to maintain the highest level of contrast. One example of this is certain nutritional preparations, such as calcium and phosphorous. When the levels of calcium and phosphorous in the compounded dose are incorrect, a white precipitate may form and render the preparation inappropriate for administration to a patient, which precipitate may alert an operator of the error. Other drugs may change to certain colors (for example, pink or purple) when erroneous levels of compounds are mixed, making a white background preferable in order to visualize the color and intensity of the change. Furthermore, certain operators may prefer a light background or a dark background based purely on personal differences. Because of the variety in what background is preferable for each different compound prepared at the medical dose preparation work station 100, it is advantageous to have the flippable staging area tray 110 easily flippable between the light side 111 and the dark side 113 by an operator using the at least one indent 112a, 112b. The at least one indent 112a, 112b may also be helpful for aligning the scale-to-tray adapter 120 (described in more detail below in the description of FIGS. 3A-3E, and shown in relative position in FIGS. 1A-1I).

In yet another embodiment, the flippable staging area tray 110 comprises a screen that provides a backlight to the medicament preparation area. In such an embodiment, the screen is configured to have at least one light mode and one dark mode, which an operator may choose between depending on the required contrast for the drug being prepared. For instance, dark mode may provide no backlight with a normally dark background or a dark color backlight in order to provide high contrast with light colors of containers or drugs, while light mode may enable the light color backlight to engage for high contrast to dark color containers or drugs. In such an embodiment, it may not be necessary for an operator to manually flip the flippable staging area tray 110, but rather the flippable staging area tray 110 would be flippable in the sense that the backlight may be flipped on or off depending on the needs of the operator. In yet another embodiment, the flippable staging area tray 110 may be configured to change color based on direct control from the processor 140 without direct user input. This may be based on conditions sensed by the processor 140, such as a relatively low contrast image being captured, or by an ambient light sensor or other sensor in operative communication with the processor 140. In this way, a user does not need to worry about what background is displayed when prompted by a workflow to capture an image. A user may, however, be able to override the current condition if desired.

The flippable staging area tray 110 may also include contact points 114a-d, 134a-d. These contact points 114a-d, 134a-d allow the flippable staging area tray 110 to rest in consistent alignment on the base 105 of the medical dose preparation work station 100 in the non-scale configuration (described and shown in greater detail above in the description of FIGS. 1A-1I) and to allow the flippable staging area tray 110 to rest in consistent alignment on the top seats 126a-d of the scale-to-tray adapter 120 in the scale configuration of the medical dose preparation work station 100 (described in more detail below in the description of FIGS. 3A-3E, and shown in relative position in FIGS. 1A-1I). The flippable staging area tray 110 also has a generally symmetrical profile in a preferred embodiment, such that the flippable staging area tray 110 may be rotated 280 degrees and still have the contact points 114a-d, 134a-d align with the base 105 or the top seats 126a-d of the scale-to-tray adapter 120. This may be advantageous so that an operator does not need to concern herself with the orientation of the flippable staging area tray 110 while flipping the flippable staging area tray 110 during medicament preparation. In this manner, for example, contact points 114a and 114c may be interchangeable in terms of relative position in the medical dose preparation work station 100. In an alternative embodiment, the flippable staging area tray 110 may be symmetrical along its length and its width, such that it may be rotated in any direction by 90 degrees and still function as intended. In such an embodiment, the position of each of the contact points 114a-d, 134a-d is interchangeable with the others. Such an embodiment may employ a generally square profile or a generally circular profile for the flippable staging area tray 110, although any polygon with an even number of indices is also contemplated (for example a hexagon, an octagon, etc.).

The flippable staging area tray 110 may also include a series of peaks 118, 138 on the surfaces of the light side 111 and the dark side 113, respectively. These peaks 118 create geometries which allow for containers and instruments to reliably rest on the surfaces of the flippable staging area tray 110. For instance, if an operator needs to temporarily set down a syringe in order to complete another task, the barrel of the syringe can rest between two adjacent peaks 118, 138 while mitigating the risk that the syringe will roll along the surfaces of the flippable staging area tray 110. The peaks 118, 138 are a pyramid shape with a square base in a preferred embodiment. The pyramidal shape allows for different shapes and sizes of containers to resiliently rest in the spaces between the peaks 118, 138. In one embodiment, the light side 111 and the dark side 113 are made up primarily of a polymer, such that the peaks 118, 138 may come to a sharp point at the top of the pyramid shape without significantly increasing the risk that a container will break when placed against the peaks 118, 138 with inadvertently excessive force. In another embodiment, the light side 111 and the dark side 113 are made up primarily of a metal (preferable a light metal, such as aluminum), and the tops of the pyramidal shapes of the peaks 118, 138 are rounded or truncated in order to ensure no accidental breach of a container occurs when it is placed to rest on the flippable staging area tray 110.

The flippable staging area tray 110 may further include at least one channel 116a-e, 136a-e set into the light side 111 and the dark side 113, respectively. The at least one channel 116a-e, 136a-e provides another geometry in which an operator may rest a container during preparation of a medicament. In a preferred embodiment, the flippable staging area tray 110 includes five channels 116a-e, 136a-e on each of the light side 111 and the dark side 113, respectively. In this preferred embodiment, three channels 116a-c, 136a-c are placed transverse to the length of the flippable staging area tray 110 on each side 111, 113, with two channels 116a, 116c, 136a, 136c placed closer to the edges of the flippable staging area tray 110 on each side 111, 113, and one channel 116b, 136b placed substantially in the center of the length of the flippable staging area tray 110 on each side 111, 113. Two channels 116d, 116e, 136d, 136e are provided transverse to the width of the flippable staging area tray 110 on either side 111, 113 and are generally disposed towards the edges of the flippable staging area tray 110. In this preferred embodiment, the channels 116a-e, 136a-e create different areas on the flippable staging area tray 110 that may aid an operator in organizing where different containers and components are on the flippable staging area tray 110. The channels 116a-e, 136a-e themselves may be configured to provide a deep well for placement of certain thin, long containers and/or to provide greater protection against items leaving the surfaces of the of flippable staging area tray 110.

Different configurations of the features on the flippable staging area tray are also contemplated. For instance, one half of each surface 111, 113 may be completely flat to help accommodate IV bags being prepared. In some embodiments, a portion constituting less than half of each surface 111, 113 may be completely flat. The different features of the flippable staging area tray 110, such as the peaks 118, 138 and channels 116a-e, 136a-e may also provide reference points for pharmacy workflow management software to perform an auto-cropping operation on images and video-streams captured by the camera 108. For instance, the pharmacy workflow management software may be calibrated to the design of the surfaces 111, 113, and may then be able to recognize obstructions to the surfaces 111, 113 constituting areas of interest for the captured images or video-streams. The workflow management software may then crop out any portion of the image or video-stream not within the area of interest in order to efficiently store information on the preparation of each medical dose. The workflow management software may further provide steps for an operator to perform a flipping operation on the flippable staging area tray 110. The workflow management software may have pre-loaded steps based on a selected medicament being prepared at the medical dose preparation work station 100 which direct an operator as to which surface 111, 113 should be used at the present preparation step or which direct an operator to flip the flippable staging area tray 110 at various points in the medicament preparation. In another embodiment, the workflow management software is configured to verify that the correct surface 111, 113 is used based on an image received from the camera 108. The image used to verify the correct surface 111, 113 may be an image of the surface 111, 113 without any medicament or containers on it, or alternatively may be based on a recorded image of the drug preparation container. In another embodiment, the workflow management software generates an alert when it determines that the incorrect surface 111, 113 was used for the given step in the medicament preparation. The workflow management software may then prompt the operator to flip the flippable staging area tray 110 to the correct surface 111, 113 and cause another image to be captured from the camera 108. In one embodiment, the workflow management software does not allow the operator to proceed to the next step in the workflow until the correct surface 111, 113 is used.

### Scale-to-Tray Adapter

Turning now to FIGS. 3A-3E, the scale-to-tray adapter 120 of the medical dose preparation work station 100 is depicted in further detail. The scale-to-tray adapter 120 includes a body 124 with a cutout portion 125. In a preferred embodiment, the body 124 is generally rectangular to match the profile of the flippable staging area tray 110. The body 124 includes at least one top seat 126a-d. In a preferred embodiment, the scale-to-tray adapter 120 has four top seats 126a-d. The top seats 126a-d are configured to align with and seat the contact points 114a-d, 134a-d of the flippable staging area tray 110 (as discussed in further detail above in the description of FIGS. 2A-2E). In one embodiment, the top seats 126a-d are made of a flexible polymer, such that the points of the contact points 114a-d, 134a-d partially sink into and are held in place by the top seats 126a-d due to the weight of the flippable staging area tray 110. In another embodiment, the top seats 126a-d are magnetic and the contact points 114a-d, 134a-d at least partially include a ferromagnetic material, such that a magnetic threshold must be overcome for an operator to move the flippable staging area tray 110 out of position, and the flippable staging area tray 110 is held in place during preparation of a medical dose.

The body 124 also includes at least one flange 122a, 122b, which preferably align with the at least one indent 112a, 112b such that the at least one flange 122a, 122b extends at least partially into the at least one indent 112a, 112b and fits in the space between the alignment knobs 109a, 109b and the at least one indent 112a, 112b when the medical dose preparation work station 100 is in the scale configuration. The at least partial extension of the at least one flange 122a, 122b into the at least one indent 112a, 112b also further ensures proper alignment of the scale-to-tray adapter 120 and the flippable staging area tray 110 in the medical dose preparation work station 100.

The body 124 is configured to be seated on the perimeter of a scale for gravimetric dose preparation. The scale, preferably a Mettler Toledo™ MX6002 precision scale, may be placed on the base 105 and the cutout portion 125 substantially surrounds the perimeter of the scale, such that a portion of the body 124 of the scale-to-tray adapter 120 rests upon the measuring surface of the scale. The flippable staging area tray 110 then rests upon the scale-to-tray adapter 120, such that the weight force of any medicament or container on the flippable staging area tray 110 is translated through the scale-to-tray adapter 120 to the scale for measurement.

### Pharmacy Preparation System

Turning now to FIG. 4, a pharmacy preparation system 200 is depicted that includes the medical dose preparation work station 100 in operative communication with a pharmacy preparation computer 260. The pharmacy preparation computer 260 may be any computer provided to a pharmacist for the preparation of medication doses, and may include for example a dedicated processor and memory. The pharmacy preparation computer 260 may be communicatively coupled to a pharmacy server 270 through a pharmacy network 280 to which both the pharmacy preparation computer 260 and the pharmacy server 270 are communicatively coupled.

In some embodiments, the medical dose preparation work station 100 is communicatively coupled directly to the network 280 (i.e. bypassing or in addition to the pharmacy preparation computer 260) through the processor 140. The processor is in operative communication with each of the memory 150, camera 108, and buttons 106a, 106b in turn.

A pharmacy preparation system 200 is thereby formed configured for use with the above disclosed embodiments of the medical dose preparation work station 100.

### Conclusion

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain known modes of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

What is claimed is:

1. A medical dose preparation work station comprising:
a base;
an imaging device disposed inside an imaging device housing, the imaging device having an imaging field including a medical dose preparation staging region, the imaging device being operable to output digital image data of the imaging field including the medical dose preparation staging region;
an adjustable arm configured to couple the imaging device housing to a base of the work station;
at least one button disposed on the base of the work station;
a tray with a perimeter corresponding to a boundary of the imaging field and defining the medical dose preparation staging region, the tray comprising:
a first side of a substantially light color; and
a second side of a substantially dark color,
wherein the first side and the second side are disposed on generally opposite sides of the tray; and
a processor in operative communication with the imaging device and the display device, the processor configured to:
receive input from the at least one button; and
provide input commands to the imaging device,
wherein the tray is configured to be flippable and reversible in the work station.

2. The medical dose preparation work station of claim 1, wherein the tray further comprises a plurality of peaks on each of the first side and the second side.

3. The medical dose preparation work station of claim 2, wherein each peak comprises a pyramidal structure having a square base.

4. The medical dose preparation work station of claim 1, wherein the tray further comprises a plurality of channels on each of the first side and the second side.

5. The medical dose preparation work station of claim 1, wherein the base further comprises at least one alignment knob, and wherein the tray further comprises at least one indent configured to align with the at least one alignment knob.

6. The medical dose preparation work station of claim 1, wherein the at least one button comprises a membrane button configured to be sterilizable.

7. The medical dose preparation work station of claim 1, wherein the base comprises a first connector, wherein the imaging device housing comprises a second connector, and wherein the adjustable arm is configured to be coupled to the imaging device housing and the base by the first and second connectors.

8. The medical dose preparation work station of claim 7, wherein the adjustable arm comprises a length configured to correspond to a focal length of the imaging device such that an object on the tray is in focus of the imaging device.

9. The medical dose preparation work station of claim 8, wherein the adjustable arm is configured to be removably coupled to the first and second connectors, and wherein the adjustable arm is interchangeable with a second adjustable arm of a different length than the adjustable arm, the second adjustable arm configured to be coupled to the imaging device housing and the base by the first and second connectors.

10. The medical dose preparation work station of claim 1, wherein the work station further comprises an adapter configured to be disposed between the tray and a scale, wherein the adapter comprises a cutout portion adapted to substantially surround a weighing surface of the scale.

11. The medical dose preparation work station of claim 10, wherein the adapter further comprises at least one flange configured to be disposed at least partially between the at least one alignment knob of the base and the at least one indent of the tray.

12. The medical dose preparation work station of claim 10, wherein the adapter further comprises a plurality of seats, wherein the tray further comprises a plurality of contact points on each of the first side and the second side, the contact points arranged to be seated on the seats of the adapter and align the tray with the adapter.

13. A tray of a medication preparation work station, the tray comprising:
a first side of a substantially light color; and
a second side of a substantially dark color,
wherein the first side and the second side are disposed on generally opposite sides of the tray.

14. The tray of claim 13, wherein the tray further comprises a plurality of peaks on each of the first side and the second side.

15. The tray of claim 14, wherein each peak comprises a pyramidal structure having a square base.

16. The tray of claim 13, wherein the tray further comprises a plurality of channels on each of the first side and the second side.

17. The tray of claim 16, wherein the channels define perimeters of a plurality of subregions on each of the first side and the second side of the tray.

18. An adapter for a medication preparation work station, the adapter comprising:
a body;
a cutout portion; and
at least one flange configured to be disposed at least partially between at least one alignment knob of a base of the medication preparation work station and at least one indent of a tray,
wherein the cutout portion is adapted to substantially surround a weighing surface of a scale.

19. The adapter of claim 18, wherein the adapter further comprises a plurality of seats, wherein the seats are configured to seat and align with a plurality of contact points of the tray.

20. The adapter of claim 18, wherein the adapter is configured to be removable from the medication preparation work station.
